(19) United States
(12) Patent Application Publication
(10) Pub. No.: US 2008/0143302 A1
(43) Pub. Date: Jun. 19, 2008

(54) ELECTRICAL POWER GENERATION SYSTEM

(75) Inventor: Charles Pierce, Cleveland, OH (US)

Correspondence Address: CALFEE HALTER & GRISWOLD, LLP, 800 SUPERIOR AVENUE, SUITE 1400, CLEVELAND, OH, 44114, US

(73) Assignee: REGEN TECHNOLOGIES, INC., SHAKER HEIGHTS, OH (US)

(21) Appl. No.: 11/957,932

(22) Filed: Dec. 17, 2007

Related U.S. Application Data
(60) Provisional application No. 60/870,451, filed on Dec. 18, 2006.

(51) Int. Cl. H02K 7/02

(52) U.S. Cl. 322/4

(57) ABSTRACT

An electrical power generation system includes a kinetic energy storage device that drives at least one electric generator. A starter mechanism is coupled to the kinetic energy storage device to store an initial amount of kinetic energy in the storage device. At least one drive motor is also coupled to the kinetic energy storage device. The drive motor is configured to input kinetic energy into the kinetic energy storage device after the starter mechanism has input the initial amount of kinetic energy into the storage device to maintain the amount of kinetic energy in the storage device at an operational level. Some of the electrical power from the generator is used to power the drive motor and the remainder of the electrical power is output by the system.

### CROSS REFERENCE TO RELATED APPLICATIONS

This non-provisional application claims the benefit of U.S. Provisional Patent Application No. 60/870,451, entitled “Electric Power Generation System,” filed on Dec. 18, 2006, the entire disclosure of which is incorporated herein by reference, to the extent that it is not conflicting with the present disclosure.

### BACKGROUND

As the cost of fossil fuels and concerns about their effect on the environment increases, electric power generation systems that rely less on fossil fuels to generate electricity are becoming more advantageous.

### SUMMARY

An electric power generation system includes a starter mechanism and at least one drive motor coupled to a kinetic energy storage device, such as, for example, a flywheel. The kinetic energy storage device is coupled to at least one electric power generator and mechanically drives the generator. The starter mechanism is powered by an external power source to turn the generator through the kinetic energy storage device until the generator is generating sufficient electric power to power the drive motor. The drive motor is then powered by the generator and drives the generator through the kinetic energy storage device. A portion of the power generated by the generator is input to power the drive motor.

### BRIEF DESCRIPTION OF THE DRAWINGS

Further features and advantages of this invention will become apparent from the following detailed description made with reference to the accompanying drawings.

FIG. 1 is a schematic view of power generating and storing components arranged in an electric power generation system constructed in accordance with a an embodiment of the present invention;

FIG. 2 is a side plan view of an exemplary mechanical arrangement of the components of FIG. 1;

FIG. 3 is a rear cross section of the exemplary mechanical arrangement of the components of FIG. 2;

FIG. 4 is an electrical schematic diagram showing electrical connections between the components of FIGS. 1-3; and

FIG. 5 is a flowchart outlining operation of a power generation system constructed in accordance with an embodiment of the present invention.

### DESCRIPTION

This Description merely describes embodiments of the invention and is not intended to limit the scope of the specification or claims in any way. Indeed, the invention as described by the specification and claims is broader than and unlimited by the preferred embodiments, and the terms used in the specification and claims have their full ordinary meaning.

The electrical power generation system of the present invention includes a kinetic energy storage device that drives at least one electric generator. A starter mechanism is coupled to the kinetic energy storage device to store an initial amount of kinetic energy in the storage device. At least one drive motor is also coupled to the kinetic energy storage device. The drive motor is configured to input kinetic energy into the kinetic energy storage device after the starter mechanism has input the initial amount of kinetic energy into the storage device to maintain the amount of kinetic energy in the storage device at an operational level. Some of the electrical power from the generator is used to power the drive motor and the remainder of the electrical power is output by the system.

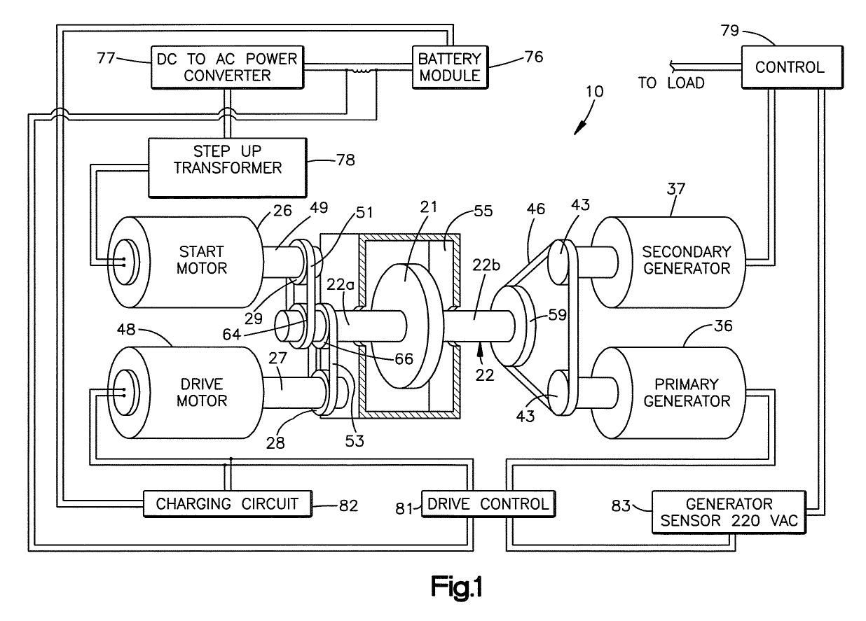

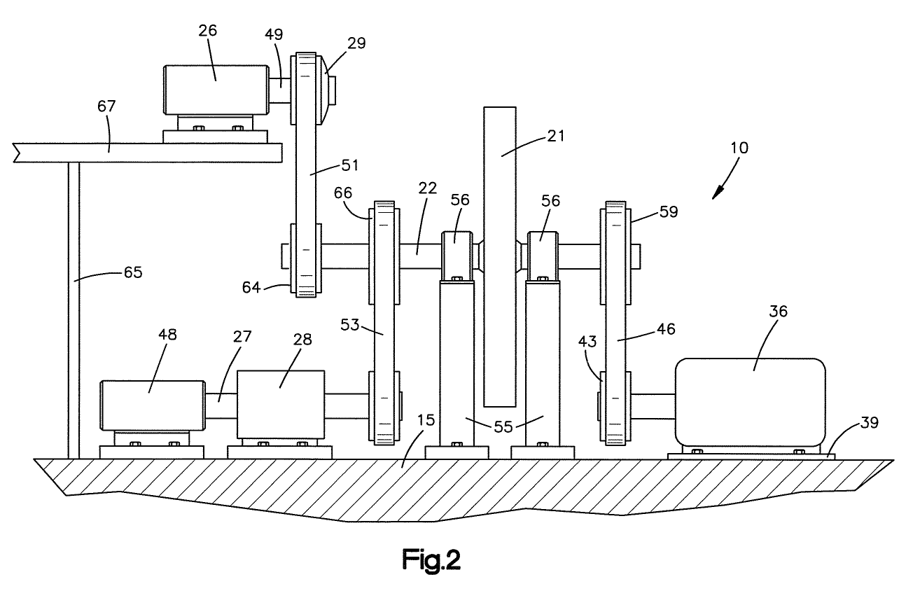

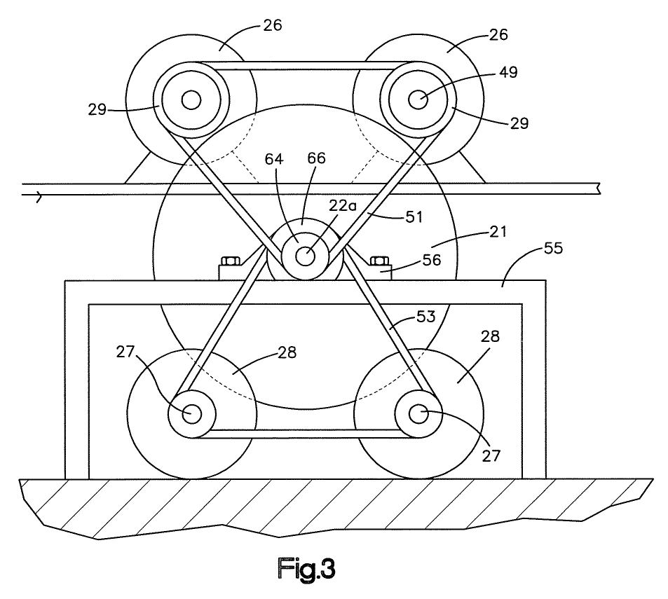

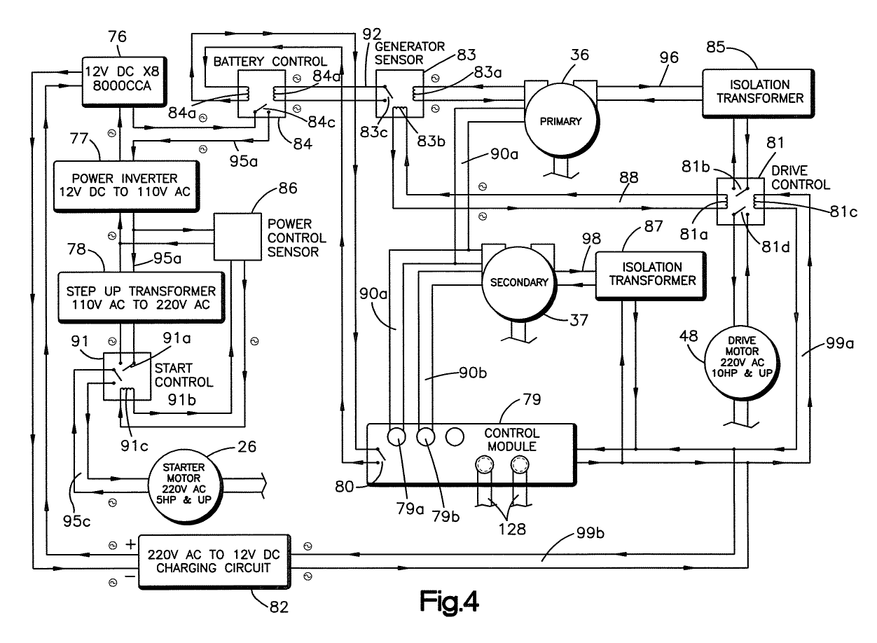

FIGS. 1-3 provide an overview of a power generation system 10 that generates electrical power. FIG. 1 is a simplified schematic illustration that does not show the components in their proper positions with respect to one another and omits some of the structural supports for the various components. In addition, FIG. 1 shows a single start motor and drive motor while the described embodiment includes two start motors and two drive motors. FIGS. 2 and 3 better illustrate the mechanical layout of the power generation system 10 while omitting the electrical connections between the components. FIG. 4 provides the best detail of the electrical connections between the components.

Referring to FIG. 1, the power generation system 10 includes a kinetic energy storage device in the form of a flywheel 21 shown supported by flywheel support structure 55. In other embodiments, the kinetic energy storage device could be of any suitable form, such as, for example, a spring. In the described embodiment, the flywheel has a diameter of 18 inches and a mass of 65 pounds. The flywheel includes a shaft 22 that has two portions: an input portion 22a and an output portion 22b. The flywheel stores kinetic energy that is output on the shaft's output portion 22b. The output portion 22b is mechanically fixed to a pulley 59 that drives a generator belt 46. The generator belt is in turn coupled to a generator pulley 43 that is coupled to an input drive shaft on each generator. In this manner, rotational motion of the flywheel is transferred via the pulleys 43, 59 and belt 46 to drive the two generators 36, 37. In the described embodiment, both generators 36, 37 are rated at 220 V AC, 10 KW.

Power output by the primary and secondary generators 36, 37 is routed to an external load, such as an electrical power grid. The control module 79 monitors the electrical power output by the generators and controls various power generation control components based on the output electrical power as will be described in more detail below.

A kinetic energy storage device starter mechanism in the form of two start motors 26 (only one shown in FIG. 1) is configured to start rotation of the flywheel 21. In the described embodiment, each start motor is powered by 220 V AC and rated for 5 horsepower. As can also be seen in FIGS. 2 and 3, each start motor includes an output shaft 49 that is coupled to a centrifugal clutch 29. In the described embodiment the centrifugal clutch is rated for 24 foot-pounds of torque and engages at 2000 RPM. The centrifugal clutch 29 engages to transfer the rotation of the output shaft of each start motor to a start motor belt 51 when the output shaft 49 is rotating faster than 2000 RPM. At this operational speed the shaft can rotate the flywheel at a speed that causes the generators to output their rated power. The start motor belt 51 is coupled to a start pulley 64 on the input portion 22a of the flywheel shaft. In this manner, the start motors can be activated to spin up the flywheel until the flywheel is rotating at an operational speed that is selected to drive the generators 36, 37 to output a desired rated amount of electrical power, in the described embodiment, the rated power of the generators is approximately 10 KW each at 220 V AC.

Each start motor 26 is powered by a battery module 76 that includes eight 12 V DC batteries, each capable of providing 8000 cold cranking amperes. DC power from the battery module is converted to AC power by a DC to AC power converter 77 that converts the batteries' 12 V DC to 110 V AC. A step up transformer 78 steps the 110 V AC up to 220 V AC that can be used to power the start motors 26. While AC start motors are used to start the flywheel in the described embodiment, it will be recognized by one of skill in the art that DC motors or any other means of providing the initial kinetic energy for storage in the kinetic energy storage device can be used in accordance with the present invention.

Once the flywheel is rotating at the operational speed and the generators are generating their rated power, the source of the flywheel's input power is transferred from the start motors 26 to the drive motors 48. In the described embodiment, the drive motors are rated for 10 horsepower at 220 V AC. An output shaft 27 of each drive motor 48 is mechanically coupled to the flywheel 21 through an electronically controlled electric clutch 28. In the described embodiment, the electric clutch is an electromagnetic clutch rated for 60 horsepower. The clutch is coupled to a drive motor belt 53 (also shown in FIGS. 2 and 3) that engages a drive belt pulley 66 on the input portion 22a of the flywheel shaft. The electric clutch 28 is controlled by the control module 79 to selectively couple the drive motor shaft 27 to the flywheel when the drive motor speed matches the flywheel's speed. When the electric clutch 28 is engaged, power is disconnected from the start motors 26. Thus during steady state operation, the drive motors 48 maintain the kinetic energy stored in the flywheel and the flywheel continues to spin the generators to generate electric power. It is believed that the kinetic energy storing flywheel smoothes the effects of transitioning between start and drive motors and can compensate for momentary reductions in input power to the system. During steady state operation, the electrical power from the primary and secondary generators is supplied to a load and any excess power can be placed on an electrical grid. Power from the primary generator is also input to the drive motor and used to charge the battery module 76.

The control module 79 is shown schematically in FIG. 1 as monitoring the output power from the generators 36, 37. The output of the primary generator 36 is also connected to a generator sensor 83. As will be described in more detail with reference to FIG. 4, the generator sensor 83 includes a coil that is in communication with the output of the primary generator. When the generator sensor coil is energized by the generator at its rated power, the generator sensor acts on a drive control contactor 81 to provide a power path between the primary generator and the drive motors 48. When the power path through the drive control contactor 81 is closed, the power from the generator starts the drive motors 48. In addition, the drive control contactor 81 provides a power path from the primary generator to the battery module 76 to a charging circuit 82 that recharges the batteries in the battery module 76.

Referring now to FIG. 2, a side view of an exemplary layout of the components for the power generation system 10 is shown. The flywheel 21 is mounted on flywheel support blocks 55. As can also be seen in FIG. 3, the flywheel shaft 22 is supported on bearings 56 that are connected to a mounting surface of the support blocks 55. In the described embodiment, the bearings are one inch saddle bearings with case hardened rollers. The generators 36, 37 (37 not shown in FIG. 2) are set on support platforms 39 on a bottom reference surface 15. The start motors 26 are set on a start motor platform 67 supported by legs 65. The platform 67 aligns the start motor output shaft 49 and centrifugal clutch 29 above the flywheel shaft 22 as can be seen best in FIG. 3. The drive motors 48 and electric clutches 28 are set upon the reference surface 15.

FIG. 3 is a rear cross section view of the power generation system 10. As can be seen best in this figure, both the start motor belt 51 and the drive motor belt 53 are arranged in a delta configuration. The start motor belt 51 is driven by both start motors 26 through the centrifugal clutches 29 and drives the start pulley 64 on the flywheel shaft 22. The drive motor belt 53 is driven by both drive motor shafts 27 through electric clutches 28 and drives the drive belt pulley 66.

Referring now to FIG. 4, an electrical schematic of the power generation system is presented. As already discussed, the control module 79 senses the electrical power generated by the generators 36, 37. In addition, the control module displays the amount of electrical power being generated by the electrical generators on gauges 79a, 79b. The control module 76 includes a start switch 80 that is closed to start the system. The start switch energizes a coil 84a in a battery contactor 84 along a power path 93. When the coil 84a is energized, a switch 84c closes. With the switch 84c closed, the battery contactor 84 is in a condition in which battery power from the battery module 76 can flow through the contactor 84 to the power inverter 77 and step up transformer 78 on the power path 95a. The power flowing through the power inverter on power path 95a is monitor by a power control sensor 86. When the power control sensor senses a sufficient amount of power to run the start motors, a coil 91c in a start control contactor 91 is energized on power path 95b. The energized coil 91c actuates switches 91a, 91b in the start control contactor 91 to connect the power path 95a to a power path 95c to provide power to the start motor 26.

Once the start motors 26 spin the flywheel (not shown in FIG. 4) and the generators, the generators will begin generating power. Two coils 83a, 83b in the generator sensor 83 are energized by the output of the primary generator 36. When the coils 83a, 83b are energized, a switch 83c in the generator sensor closes. When the switch 83c closes, a coil 84b in the battery contactor is energized along a power path 92, opening the switch 84c in the battery contactor to disconnect the power path between the battery module 76 and the start motors 26. The start motors are thus disconnected from power and will lose output shaft speed. Once the shaft speed falls below 2000 RPM, the centrifugal clutches 29 will disengage and the start motors are disconnected from the flywheel. In this manner, if the primary generator is generating rated power, then the battery contactor 84 will prevent the flow of power between the battery module 76 and the start motors are disconnected from the flywheel.

When the primary generator is generating rated power, the coil 83b is energized and in turn energizes a coil 81a along a power path 88. The coil 81a is part of the drive control contactor 81. When the coil 81a is energized, another coil 81c becomes energized which provides power along power path 99a to the control module 79 to indicate that the primary generator is generating rated power. When the control module 79 receives this signal, the control module powers the electric clutches 28 via power outputs 128 to connect the output shaft of the drive motor 48 to the flywheel. The signal on power path 99a is branched to a power path 99b that provides power to the charging circuit 82 that charges that batteries in the battery module 76. In addition, when the coil 81a is energized, switches 81b, 81d in the drive control contactor 81 are closed to connect power from the primary generator 36 to the drive motor along a power path 96. In this manner, when the primary generator is generating rated power, the generator sensor 83 causes power to be supplied to the drive motor and provides a signal to the control module to engage the electric clutches on the drive motors.

The primary generator 36 and the secondary generator 37 are connected to isolation transformers 85, 87, respectively through which electrical power is supplied to the load (not shown in FIG. 3). The isolation transformers may be, for example, 220 V AC to 220 V AC transformers. The various contactors such as the battery control contactor 84, generator sensor 83, start control contactor 91, and drive control contactor 81 can be implemented in the form of relay boxes containing 24 V DC or 110 V AC relays as appropriate. The contactors may also be implemented with other means such as solid state switches. The contactors may be replaced by control components within the control module that are operated according to a stored control algorithm. The contactors may all be centrally located within the control module 79 or located in proximity to the devices they control.

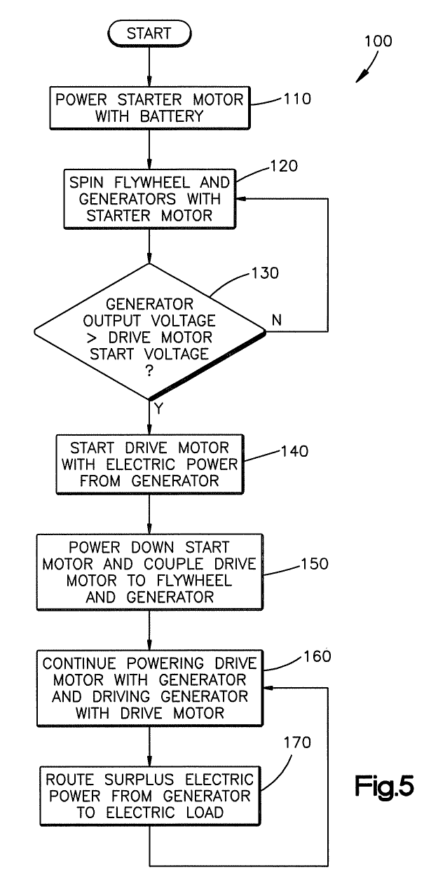

FIG. 5 is a flowchart outlining a procedure 100 that can be used to operate the power generation system. During power generation system initial start up the start motor is powered with the power from the battery module at 110. This is accomplished by energizing the battery control contactor 84 to allow the flow of power from the power converter 77 to the step up transformer 78 (FIG. 4). The power control sensor 86 connects power from the step up transformer 78 to the start motor 26 when the power level is sufficient to run the start motor. The start motor begins to spin and once the centrifugal clutch 29 is engaged, the start motor spins the flywheel and generator (or generators, if a secondary generator is used) at 120. The flywheel stores kinetic energy from the start motor and drives the generator. The flywheel has a damping effect on variations in motor output shaft speed. At 130 the electrical output of the generator is compared to power required to power the drive motor and as long as the generator is not producing rated power, the generator sensor 83 maintains the battery control contactor 84 in condition to connect power from the battery module 76 to the start motors 26. At 140, once the generator's output power is sufficient to power the drive motor the generator sensor 83 controls the drive control contactor 81 to connect the generator's output to the drive motor 48. It is believed that isolating the generator's electrical output from the drive motor until sufficient voltage is available to operate the drive motor prevents back EMF from being generated and causing electrical interference between the drive motor and generator.

The output of the drive motor is coupled to the pulleys that drive the flywheel through the electric clutch 28. Initially, the clutch uncouples the rotation of the drive motor's output shaft from the flywheel until the drive motor's speed matches that of the flywheel. The electric clutch 28 is engaged by the control module 79 after a time delay during which time the drive motor gets up to flywheel speed. At 150 once the drive motor is up to speed, the electric clutch is engaged and the drive motor's output shaft is coupled to and drives the flywheel. The start motor is powered down by the generator sensor 83 energizing the battery contactor coil 84b. The flywheel damps the mechanical effects of the change in motors that are transmitted to the generator. Once the drive motor is driving the flywheel and the start motor is shut down, the system is in a steady state mode at 160 and 170 in which power from the generator is input to the drive motor and generator power is supplied to the load.

While several embodiments of the invention has been illustrated and described in considerable detail, the present invention is not to be considered limited to the precise constructions disclosed. Various adaptations, modifications and uses of the invention may occur to those skilled in the arts to which the invention relates. It is the intention to cover all such adaptations, modifications and uses falling within the scope or spirit of the specification and claims filed herewith.

I claim:

1. A method that generates electrical power comprising:
storing kinetic energy in a kinetic energy storage device;
driving an electrical generator with the kinetic energy storage device;
when the electricity generated by the electrical generator is sufficient to power a drive motor, coupling electricity generated by the electrical generator to start the drive motor; and
storing kinetic energy from the drive motor in the kinetic energy storage device.

2. The method of claim 1 wherein the step of storing kinetic energy is performed by spinning a flywheel.

3. The method of claim 2 wherein the step of spinning a flywheel is performed by engaging the fly wheel with a drive shaft of a motor that is energized with a power storage device.

4. The method of claim 1 wherein the step of coupling electricity generated by the electrical generator to the drive motor is performed by providing power from the electrical generator to an isolation transformer that transfers power from the electrical generator to the drive motor.

5. The method of claim 1 wherein the step of storing kinetic energy from the drive motor in the flywheel is performed by sensing a rotational speed of an output shaft of the drive motor and a flywheel speed and engaging a clutch disposed between the output shaft and the flywheel when the drive motor speed matches the flywheel speed.

6. An electrical power generating system comprising:
a kinetic energy storage device;
a starter mechanism configured to provide an initial amount of kinetic energy to the kinetic energy storage device sufficient to place the kinetic energy storage device in an operational mode;
an electrical power generator coupled to the kinetic energy storage device, the electrical power generator configured to output a rated amount of electrical power when the kinetic energy storage device is in the operational mode;
a kinetic energy storage device driver configured to input kinetic energy to the kinetic energy storage device when the kinetic energy storage device is in the operational mode;
a control switch component that couples a portion of the rated amount of electrical power from the electrical power generator to the kinetic energy storage device driver;
a clutch mechanism that transfers the source of input kinetic energy to the kinetic energy storage device from the starter mechanism to the kinetic energy storage device driver; and
a controller configured to monitor an output electrical power from the electrical power generator and when the electrical power generator is providing the rated amount of electrical power controlling the control switch to energize the kinetic energy storage device driver and causing the clutch mechanism to transfer the source of input kinetic energy to the kinetic energy storage device from the starter mechanism to the kinetic energy storage device driver.

7. The electrical power generating system of claim 6 wherein the kinetic energy storage device comprises a flywheel.

8. The electrical power generating system of claim 6 wherein the starter mechanism comprises an electric motor coupled to the kinetic energy storage device.

9. The electrical power generating system of claim 6 wherein the kinetic energy storage device driver comprises an electric motor.

10. The electrical power generating system of claim 6 wherein the kinetic energy storage device comprises a flywheel and the starter mechanism comprises an electric start motor coupled to the flywheel and further wherein the clutch mechanism comprises a centrifugal clutch disposed between the electric start motor and the flywheel.

11. The electrical power generating system of claim 6 wherein the kinetic energy storage device comprises a flywheel and the kinetic energy storage device driver comprises an electric driver motor coupled to the flywheel and further wherein the clutch mechanism comprises an electric clutch disposed between the electric start motor and the flywheel.

12. A control system for an electrical power generating system that includes a flywheel coupled between a drive motor that is configured to drive the flywheel through a drive clutch mechanism and a generator that is configured to be driven by the flywheel to generate electrical power and further comprises a starter mechanism that selectively drives the flywheel until the flywheel is operating at an operation speed, the control system comprising:
a generator sensor that senses an amount of power output by the generator;
a start control module that is in signal communication with the generator sensor and is configured to cause the starter mechanism to drive the flywheel when the amount of power output by the generator is below a threshold amount;
a drive control module that is in signal communication with the generator sensor and is configured to route power output by the generator to the drive motor when the generator is generating a rated amount of power; and
a control module that monitors the amount of power output by the generator and controls the drive clutch mechanism to couple the drive motor to the flywheel when the generator is generating the rated amount of power.

13. The control system of claim 12 wherein the starter mechanism comprises a start motor and wherein the electrical power generating system includes a battery module configured to provide power to the start motor, the control system comprising a battery control module that is in signal communication with the generator sensor and configured to electrically connect batteries in the battery module to the start motor when the generator is generating less than the rated amount of power.

14. The control system of claim 12 wherein at least one of the generator sensor, drive control module, and control module comprise a coil that is configured to be energized by an output of the generator when the generator is generating the rated amount of power and one or more switches that are actuated by the coil based on a coil energization state.

15. The control system of claim 13 comprising a battery power control system that monitors electrical power output by the battery module and signals the start control module to connect electrical power from the battery control module to the start motor when the electrical power output by the battery module is above a threshold amount.
